(19) United States
(12) Patent Application Publication
(10) Pub. No.: US 2011/0240792 A1
(43) Pub. Date: Oct. 6, 2011

(54) TRANSMISSION OF INFORMATION TO A SYSTEM UTILIZING A GPS DEVICE

(75) Inventors: Yair Oren, Washington, DC (US); Stanley B. Alterman, Jupiter, FL (US)

(73) Assignee: MOBILEACCESS NETWORKS LTD., Vienna, VA (US)

(21) Appl. No.: 13/162,212

(22) Filed: Jun. 16, 2011

Related U.S. Application Data
(63) Continuation of application No. 12/028,201, filed on Feb. 8, 2008, now abandoned.
(60) Provisional application No. 60/889,033, filed on Feb. 9, 2007.

(51) Int. Cl. F42B 15/01; F42C 19/00; H04B 1/707

(52) U.S. Cl. 244/3.19; 102/206; 375/141; 375/E01.002

(57) ABSTRACT

A system for transmitting non-GPS information for reception by a global positioning system (GPS) receiver, the system including a processor, a memory coupled to the processor and including computer-readable instructions configured to, when executed by the processor, cause the processor to receive the non-GPS information, determine an available pseudo-random noise (PRN) code, spread the non-GPS information using the available PRN code to provide a spread signal, modulate a GPS carrier frequency using the spread signal to produce a GPS compatible signal, and a terrestrial transmitter configured to transmit the GPS compatible signal.

### CROSS-REFERENCE TO RELATED APPLICATIONS

The present application is a continuation patent application of U.S. Ser. No. 12/028,201 filed on Feb. 8, 2008, entitled “Transmission of Information to a System Utilizing a GPS System,” which claims priority to U.S. Provisional Patent Application Ser. No. 60/889,033 filed on Feb. 9, 2007, entitled “Transmission of Information to a System Utilizing a GPS System,” each of which are incorporated herein by reference in their entireties.

### STATEMENT REGARDING FEDERALLY SPONSORED RESEARCH

Not Applicable

### REFERENCE TO MICROFICHE APPENDIX

Not Applicable

### BACKGROUND

Global positioning system (GPS) receivers are widely used and have many potential applications. Many electronic devices now include GPS receivers such as mobile phones, in-car navigation systems, and vehicular-guidance systems. An electronic device containing a GPS receiver is capable of precisely determining the location (plus or minus a few centimeters) of the electronic device, anywhere in the world. Generally, using a GPS device, a user is able to obtain position information in terms of latitude, longitude, and altitude. The position information can then be processed into other forms of information, such as a location on a map or a Postal Code.

GPS receivers can use signals from a combination of satellite-based transmitters and ground-based transmitters to calculate the receiver's position. Referring to FIG. 1, orbiting the Earth is a constellation of twenty-four satellites (A, B, C, D, E, F) in six planes. Each of the satellites transmits signals modulated by a pseudo-random noise (PRN) code towards the Earth's surface. A unique PRN code (also known as a “gold code”) is assigned to each GPS satellite, with several spare PRN codes available. The signals can carry information that includes a coarse/acquisition code, a precision code (P-code), and a navigation message. GPS receivers calculate location information using the signals and information from at least three of the GPS satellites. By comparing the amount of time that it took for the signal transmitted by each satellite to reach the GPS receiver, and using the data contained in the signals, the GPS receiver is able to precisely calculate the location of the GPS receiver. The ground-based transmitters can monitor the GPS signals, and correct for any drift in the orbits of the GPS satellites by updating the ephemeris constant and/or the base clock offset of each of these satellites. In this manner, a user can use a GPS receiver to precisely determine the location of the GPS receiver.

The GPS satellites transmit signals over several frequencies such as the LI carrier frequency (1575.42 MHz) and the L2 carrier frequency (1227.6 MHz), and in the future, the L5 carrier frequency (1176.45 MHz). The GPS satellites use Direct Sequence Spread Spectrum (DSSS) modulation, which is a type of code-division multiple-access (CDMA) modulation, to modulate the signals transmitted by each of the GPS satellites. The signals transmitted by each of the GPS satellites (e.g., the P-code, the coarse/acquisition signal, etc.) are “spread” by the PRN code corresponding to an individual satellite. The spread signal is used to modulate a carrier frequency (e.g., the L1 and/or L2 frequencies). The modulated spread signal is broadcast to GPS receivers. The use of DSSS can increase the signal's resistance to interference. Since each signal is nearly uncorrelated with respect to each other, the DSSS modulated GPS signals can be demodulated using standard CDMA techniques.

The navigation message is a 50 Hz signal that includes data bits describing the GPS satellite orbits, clock corrections, and other system parameters. A complete navigation message is sent over the course of a 12.5-minute cycle using twenty-five 1500-bit frames. A single 1500-bit frame is sent every thirty seconds (yielding an effective throughput of 50 bps). Each 1500-bit frame is divided into five 300-bit sub-frames. The first sub-frame of each 1500-bit frame includes satellite-specific clock-correction information. The second and third sub-frames include satellite-specific ephemeris data information. The fourth and fifth sub-frames include system data, or almanac data. Combining twenty-five consecutive corresponding sub-frames (e.g., twenty-five consecutive fourth sub-frames, twenty-five consecutive fifth sub-frames, etc.) yields an entire navigation message.

The signals transmitted by the GPS satellites travel line of sight, but can have a hard time passing through solid objects such as building structures and mountains. For example, if a user has a GPS receiver inside of a 50-story building, the user may not be able to receive any GPS satellite signals. The lack of a GPS satellite signal can have disastrous consequences such as an inability for 911 call centers to locate a caller or an inability to communicate with an object and/or a vehicle, such as an automated or guided vehicle, en-route to a destination.

The Federal Communications Commission (FCC) has established a wireless Enhanced 911 (“E911”) plan. The E911 program is divided into two parts—Phase I and Phase II. Phase I requires wireless carriers to report the telephone number of a wireless 911 caller and the location of the carrier's antenna that received the call. Phase II of the E911 regulations require wireless carriers to provide far more precise location information, within 50 to 300 meters in most cases. To comply with the wireless E911 plan, many wireless carriers have integrated GPS receivers into mobile phones, and other mobile communication devices. In the event of a 911 call by a mobile phone user, the GPS enabled mobile phone can relay location information provided by the GPS receiver to a 911 call center for use in determining the location of the mobile phone.

### SUMMARY

Various aspects of the invention can provide one or more of the following capabilities. Virtually any type of information can be transmitted to GPS receivers using the existing GPS infrastructure. Information can be transmitted to GPS receivers (e.g., a device with an antenna, a radio receiver that can receive GPS signals and information, and a processor for use the worldwide GPS system) using the navigation message of a GPS signal. Information can be transmitted to GPS receivers using a terrestrial GPS transmitter such as a pseudolite (e.g., a terrestrial transmitter that can provide services typically provided by a satellite such as a GPS signal), a mobile transmitter, an airborne transmitter, a satellite or existing GPS satellites. Communication with and reprogramming of electronic devices coupled to a GPS receiver can be accomplished. GPS containing devices, vehicles and ordnances can be reprogrammed or redirected using information received in a GPS signal. By using the GPS receiver to sent information to these GPS containing devices, vehicles and ordnances, the space, weight and cost of providing a separate receiver for this information can be avoided.

Standard GPS receivers can continue to operate successfully even in the presence of information signals containing supplemental information. A transmission source can utilize signal PRN codes which are unused either in the entire GPS satellite constellation or at least with respect to the “visible” satellites at the time of the transmission. Information can be addressed to a specific GPS receiver. Information can be provided to an electronic device having no communication capability apart from an attached GPS receiver device, without redesigning the electronic device. Information can be provided to a GPS receiver using a non-interfering duty-cycle, for example, a duty cycle that is less than about 30% of existing GPS satellite transmissions. Information can be provided to a GPS receiver by modulating the information using an orthogonal code different from any of the GPS satellites. Existing GPS receivers and attached electronic devices can be reprogrammed using information transmitted in a GPS signal. Information such as, system control information or course-correction information can be transmitted to vehicular guidance systems and ordnances. Information can be transmitted to mobile and aerial vehicles and devices. Covert communication can be accomplished.

These and other capabilities of the invention, along with the invention itself, will be more fully understood after a review of the following figures, detailed description, and claims.

### BRIEF DESCRIPTION OF THE FIGURES

FIG. 1 is a schematic diagram of a constellation of GPS satellites.

FIG. 2 is a schematic diagram of a GPS system including terrestrial transmitters.

FIG. 3 is a schematic diagram of a portion of a navigation message included in a GPS signal.

FIG. 4 is a flowchart of a process for transmitting and receiving information using the system shown in FIG. 2.

FIG. 5 is a flowchart of a process for transmitting and receiving information using the system shown in FIG. 2.

FIG. 6 is a schematic diagram of an implementation of a GPS system using terrestrial transmitters.

FIG. 7 is a flowchart of a process for transmitting information to a guide vehicle.

FIG. 8 is a schematic diagram of a waveform related to the principal of orthogonality.

### DETAILED DESCRIPTION

Embodiments of the invention provide techniques for transmitting information, such as data, to a GPS receiver device without substantially interfering with standard GPS satellite signals. GPS receiver devices include electronic devices with the capability to receive GPS satellite signals, such as GPS-enabled mobile phones, in-vehicle navigation systems, vehicular guidance systems, aviation navigation systems, maritime navigation systems, etc. A transmission source transmits information to a GPS receiver using GPS-like signals. The information can be transmitted to a GPS receiver, for example, using signals with a lower (or complementary) duty-cycle than existing GPS signals and/or by modulating the signal using available PRN codes (for example, one of the spare or unused PRN codes). Depending on the chosen transmission method, the GPS receiver can use CDMA demodulation techniques to demodulate and extract the information contained in the GPS-like signals broadcast to the GPS receiver.

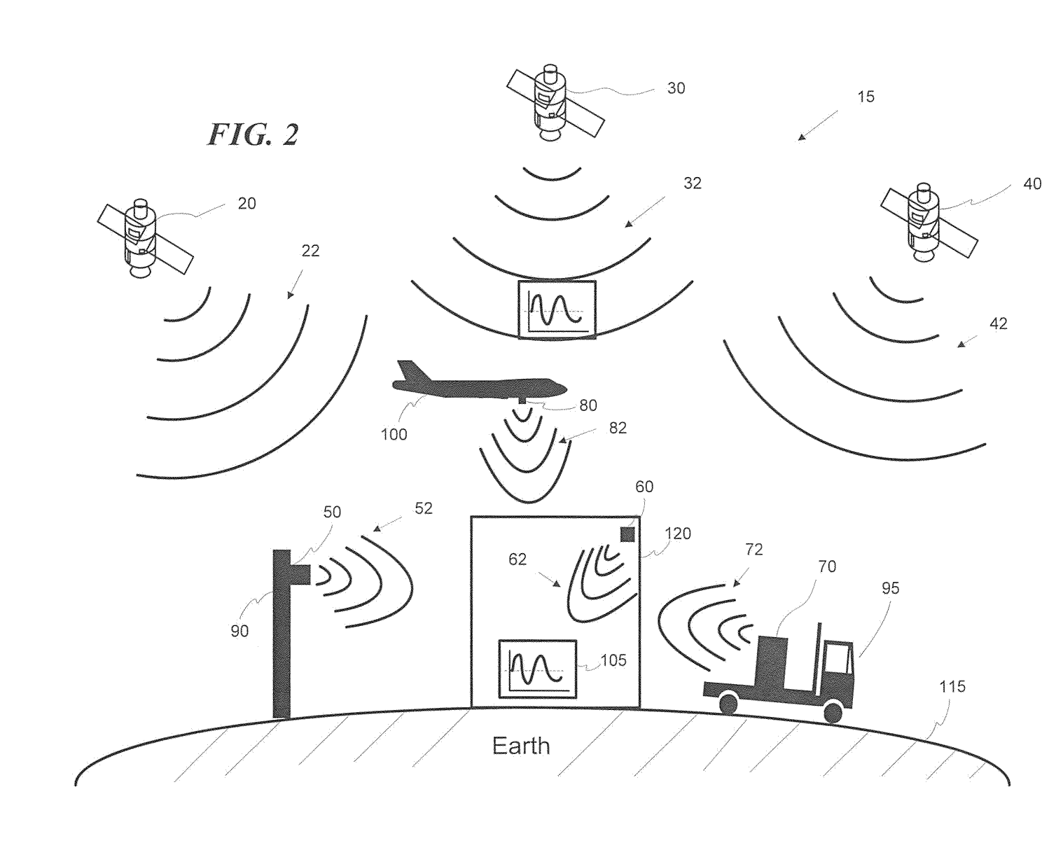

Referring to FIG. 2 a GPS system 15 includes the GPS satellites 20, 30, and 40, transmitters 50, 60, 70, and 80, signals 22, 32, 42, 52, 62, 72, and 82, a land/stationary platform 90, a mobile platform 95, an airborne platform 100 and a GPS receiver 105. The satellites 20, 30, and 40 transmit the GPS signals 22, 32, and 42 towards Earth 115 for reception by the GPS receiver 105. Supplemental “GPS-like” signals, such as signals 52, 62, 72, and 82, can be used to broadcast GPS information and/or other information to GPS receivers. Other quantities and configurations of the transmitters 50, 60, 70, and 80, the satellites 20, 30, and 40, and/or the GPS receiver 105 are possible (e.g., five satellites, one ground-based transmitter, and four GPS receivers).

The transmitters 50, 60, 70, and 80 can be used to provide GPS signals and/or GPS-like signals to the GPS receiver 105. Non-satellite transmitters can be stationary, mobile, airborne, and/or terrestrial. For example, the transmitter 50 is installed on the land/stationary platform 90, the transmitter 60 is installed within a building 120, and the transmitter 70 is installed on the mobile platform 95 (in FIG. 2, a truck). The land platform 90 can be a stationary object such as a pole dedicated to the transmitter 50 or another structure such as a radio antenna, a mobile-phone tower, a light pole, a roof of a building, a water tower, a bridge, a mountain top, etc. The mobile platform 95 can be a moving object, such as a car, a truck, a boat, a train, a bus, a tank, etc. The transmitter 80 is installed on an airplane 100, although other similar aerial vehicles can be used (e.g., a helicopter, an unmanned aerial vehicle (UAV), satellite and/or a blimp).

Non-satellite based transmitters (e.g., the transmitters 50, 60, 70, and 80) can be used to supplement (e.g., repeat) the GPS signals transmitted by the GPS satellites, and/or to send GPS-like signals including information to the GPS receiver 105. The type of information that can be broadcast to the GPS receiver 105 (or any GPS enabled device) is broad. The information can be non-GPS information which does not include information that is not intended to be used by the GPS for determining the position of the GPS receiver and can be used by the GPS receiver (or a device connected to the GPS receiver) for related or unrelated purposes. For example, the information can include information such as location information, text messages, image files, audio data or files, video data or files, reconfiguration instructions, firmware upgrades, encrypted signals, software updates, anti-virus updates, Web pages, navigation information, navigation files, e-mails, map files, document files, etc. The information can include covert communications that are encrypted or otherwise hidden, such as using steganographic methods. The information can also include information of significance to vehicular or ordnance guidance or control systems such as speed, direction destination information and updates, coordinate information and updates, operational instructions and updates, etc. Transmissions of other types of information are possible.

Information can be sent to a GPS receiver 105 using standard GPS signal formats such as the navigation message embedded in the GPS signals 22, 32, 42, 52, 62, 72, and 82. The navigation message can be replaced with other information, which can result in a bandwidth of approximately 50 bits-per-second (bps). Other data rates are possible. Other portions of a standard GPS signal can be replaced with other information. More than one of the unused PRN codes can be used to transmit data.

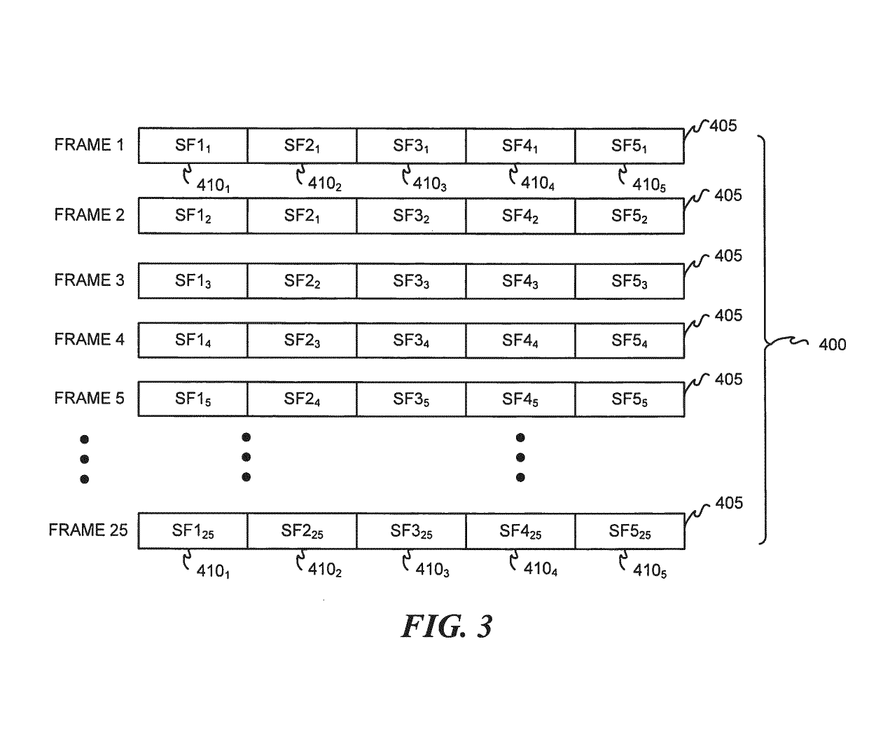

Referring also to FIG. 3, a navigation message 400 includes frames 405 and sub-frames 410i through 410s. Twenty-five of the frames 405 make up a single navigation message 400, although other quantities of frames 405 can make up an entire navigation message 400 (e.g., 50 of the frames 405 can make up a single navigation message 400). Each of the frames 405 includes five sub-frames 410i through 410s, although other quantities of sub-frames 410 can make up a single one of the frames 405 (e.g., ten sub-frames can make up a single one of the frames 405).

The information can be a single 50 bit pay load which is sent in a single one of the sub-frames 410, or can be a larger message that is split up over multiple sub-frames 410 or multiple navigation messages sent on the same or multiple PRN codes. For example, a 2000-bit message can be split up over forty consecutive sub-frames 410. The 2000-bit message could be split up over forty consecutive corresponding sub-frames (e.g., forty consecutive 4IO2 sub-frames). Other combinations are possible. The GPS receiver can reconstruct information that has been split up over multiple sub-frames, or alternatively a processor located externally from the GPS receiver can reconstruct information split up over multiple sub-frames 410.

The information transmitted by the non-satellite based transmitters can be broadcast using existing GPS frequencies such as the L1 and L2 bands, and in the future, the L5 band, although other frequency bands can be used. Because the GPS satellites can transmit on the same frequency bands as the transmitters 50, 60, 70, and 80, the signals transmitted by the transmitters 50, 60, 70, and 80 can interfere with existing GPS signals. To reduce, or even eliminate interference, information can be broadcast to GPS receivers (e.g., the GPS receiver 105) using an available PRN code to encode the information and/or using different or lower duty-cycle transmissions. Varying the duty-cycle of the transmissions (e.g., using a duty cycle of 10-30%) can reduce interference with existing GPS signals by improving the signal-to-noise ratio of the information transmitted relative to existing GPS signals. Other techniques can be used.

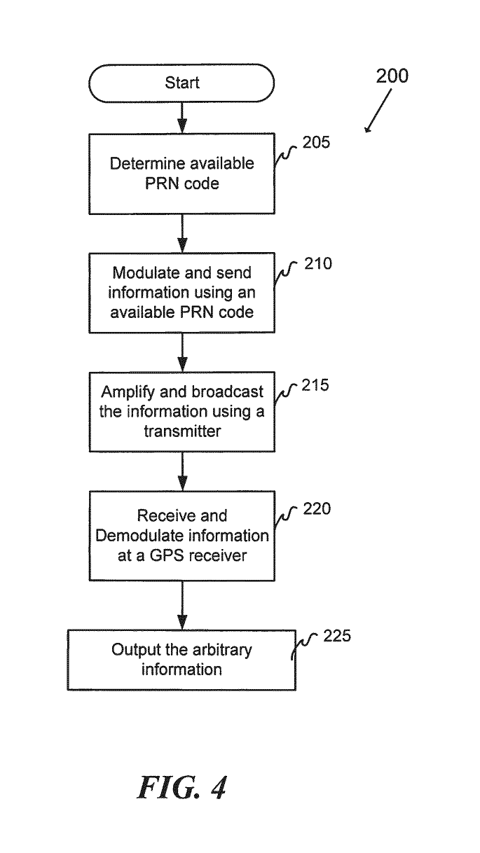

In operation, referring to FIG. 4, with further reference to FIG. 2, a process 200 for transmitting information using an available PRN code and the GPS system 15 includes the stages shown. The process 200, however, is exemplary only and not limiting. The process 200 can be altered, e.g., by having stages added, removed, or rearranged.

At stage 205 an available PRN code is identified. An available PRN code is a PRN code such as one of the spare PRN codes and/or a PRN code in use by a GPS satellite 5 that is out of view of the GPS receiver 105. If one of the spare PRN codes is chosen, the likelihood of interference with another of the GPS satellites can be reduced or even eliminated. Alternatively, a tracking module (e.g., a computer processor running the necessary software) can track the GPS satellites to determine which of the satellites are “in-view”of the GPS receiver 105 at any given time. The tracking module can select a PRN code corresponding to one of the GPS satellites that is not in-view of the GPS receiver 105 to modulate the information being broadcast by the transmitters 50, 60, 70, and/or 80. As the GPS satellites orbit the Earth 115, the availability of a particular PRN code can change. For example, in FIG. 2, the GPS satellite 30 (here, acting as one of the GPS satellites) is shown in-view of the GPS receiver 105 making its code unavailable for use in the DSSS modulation process. As the satellite 30 orbits the Earth 115, the satellite 30 can disappear over a horizon of the Earth 115, which can make its PRN code available for use by a ground based transmitter. Once the satellite 30 is again in-view of the GPS receiver, however, its PRN code becomes unavailable. The tracking module can track and/or predict which PRN code will be available at any given time.

At stage 210, the information can be sent using DSSS and the selected available PRN code. Portions of the information can be sent using one or more of the available PRN codes. For example, multiple information streams can be sent using different PRN codes, or a single information stream can be split into multiple streams that are sent using different PRN codes.

At stage 215, the sent information can be amplified and broadcast by a transmitter (e.g., the satellites 20, 30, and/or 40, and/or the transmitters 50, 60, 70, and/or 80) for reception by a GPS receiver (e.g., the GPS receiver 105). When the GPS satellites are used to broadcast non-GPS signals, cooperation by the entity operating the satellite (e.g., the United States Government) may be required.

At stage 220, the sent information can be received and amplified by a GPS receiver (e.g., the GPS receiver 105). The transmitted information can be demodulated to substantially recover the sent information. Error correction, such as a cyclic redundancy check (CRC) code with error correction capability, can be used during transmission process. At stage 225 the recovered information is output by the GPS receiver.

The stages 220 and/or 225 (including sub-portions of the stages 220 and/or 225) can be accomplished by a GPS receiver (e.g., the GPS receiver 105), or another device external to the GPS receiver. For example, the GPS receiver 105 itself can demodulate the received modulated information. Alternatively, the GPS receiver 105 (for example, a GPS receiver in a mobile device) can receive the information stream and retransmit it via a wired or wireless network to a remote processor, such as one operated by mobile phone network operator. The remote processor can then demodulate the sent information and transmit the recovered information to the GPS receiver 105 and/or the attached mobile device.

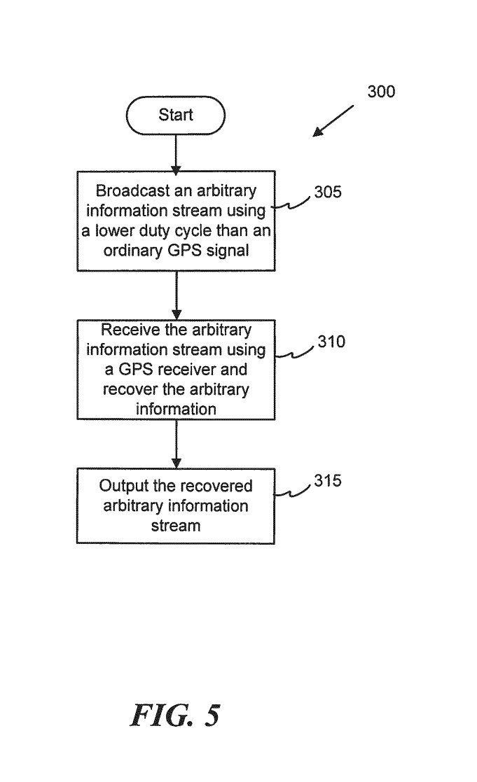

In operation, referring to FIG. 5, with further reference to FIG. 2, a process 300 for transmitting information using reduced duty-cycles and/or non-interfering duty-cycles, or PRN codes, using the GPS system 15 includes the stages shown. The process 300, however, is exemplary only and not limiting. The process 300 can be altered, e.g., by having stages added, removed, or rearranged. While the process 300 describes the 5 process of transmitting information, the process 300 can also be used to transmit standard GPS signals.

At stage 305, a transmitter (e.g., the satellites 20,30, and/or 40, and/or the transmitters 50, 60, 70, and/or 80) broadcasts the information stream using a duty cycle of about 10-30%. Other duty cycles can be used. The information stream is a modified navigation message, as described above, although other forms of the information stream are possible. Broadcasting information using a lower duty cycle than standard GPS signals can reduce, or possibly eliminate interference with standard GPS signals. The information stream is encoded using an existing PRN code. The PRN code used to encode the information stream can be a PRN code in-use by a GPS satellite for transmitting GPS signals, although unused PRN codes can be used in addition to or instead of the in-use PRN code. The encoded information stream can be broadcast at a power level higher than existing GPS signals, subject to saturation effects in the GPS transmitter and/or receiver.

At stage 310, a GPS receiver (e.g., the GPS receiver 105) receives the lower duty-cycle broadcast. The GPS receiver can be configured to detect, receive, and/or process the lower duty-cycle broadcast to recover the information contained therein. For example, correlation and integration can be used to recover the lower duty-cycle broadcast when the signal strength is below the noise floor. The GPS receiver processes the lower-duty cycle information stream such that simultaneous detection of existing GPS signals is possible. At stage 315, the GPS receiver outputs the recovered information using standard GPS spread spectrum processing (as described herein).

The stages 310 and/or 315 can be accomplished by a GPS receiver (e.g., the GPS receiver 105), or another device external to the GPS receiver. For example, the GPS receiver 105 can be configured to process the lower duty-cycle broadcast to recover the information. Alternatively, the GPS receiver can receive the lower-duty cycle broadcast and retransmit it to a remote processor using, for example, wired, cellular or other wireless transmission technology. The remote processor can process the received broadcast to recover the information, and transmit the recovered information to the GPS receiver 105 and/or the attached mobile device.

The GPS system 15 of FIG. 2 can be used to provide information to GPS receivers (here, the GPS receiver 105). When the GPS receiver is able to receive standard GPS signals, the GPS system 15 can be used to augment the standard GPS signals by providing information to the GPS receiver 105. Alternatively, in locations where the GPS receiver 105 is unable to receive standard GPS signals (e.g., within a building or a cave), the GPS system 15 can be used to relay the standard GPS signals and/or provide other information to the GPS receiver 105.

The information can be used to communicate with GPS enabled guided vehicles or ordnances. For example, some guided vehicles and ordnances can receive GPS signals such as a Global Positioning System Aided Munition (GAM). Because some GPS enabled guided vehicles are programmed with target coordinates prior to being launched, it can be desirable to be able to transmit information (e.g., updated target or destination coordinates, abort, or other control information) to the guided vehicle or ordnance after being launched while the guided vehicle is en route to a target.

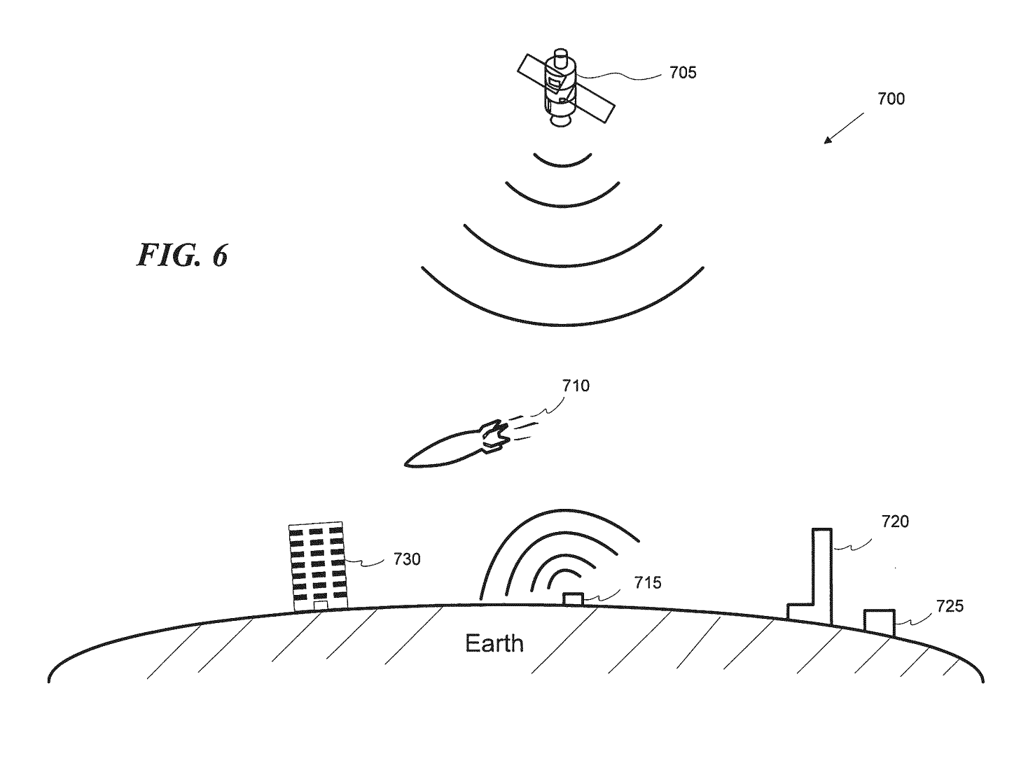

Referring to FIG. 6 a targeting system 700 includes a satellite 705, a guided vehicle (or ordnance) 710, a transmitter 715, a launch site 720, and a command center 725. The satellite 705 can be one of the GPS satellites, or can be another space vehicle such as the satellites 20, 30, and/or 40, a military satellite, a commercial satellite, a space vehicle, etc. The GPS enabled guided vehicle 710 can be launched from the launch site 720 towards a target or destination 730 by the command center 725. If the target 730 is a mobile target (e.g., a tank, a ship, etc.) that is in motion while the guided vehicle 710 is in flight, updated or new target (or destination) coordinates can be transmitted by the command center 725 to the guided vehicle 710 using the transmitter 715 and/or the satellite 705. If the target 730 changes, for example a new target is selected, while the guided vehicle 710 is in flight, updated or new target (or destination) coordinates can be transmitted by the command center 725 to the guided vehicle 710 using the transmitter 715 and/or the satellite 705. In addition or alternatively, other information, such as control information, can be transmitted to the guided vehicle 710, for example, changes in speed or direct and abort, return to base or self-destruct instructions. The command center 725 can monitor the target 730 using various methods such as radar (not shown), ground based operatives (not shown), etc.

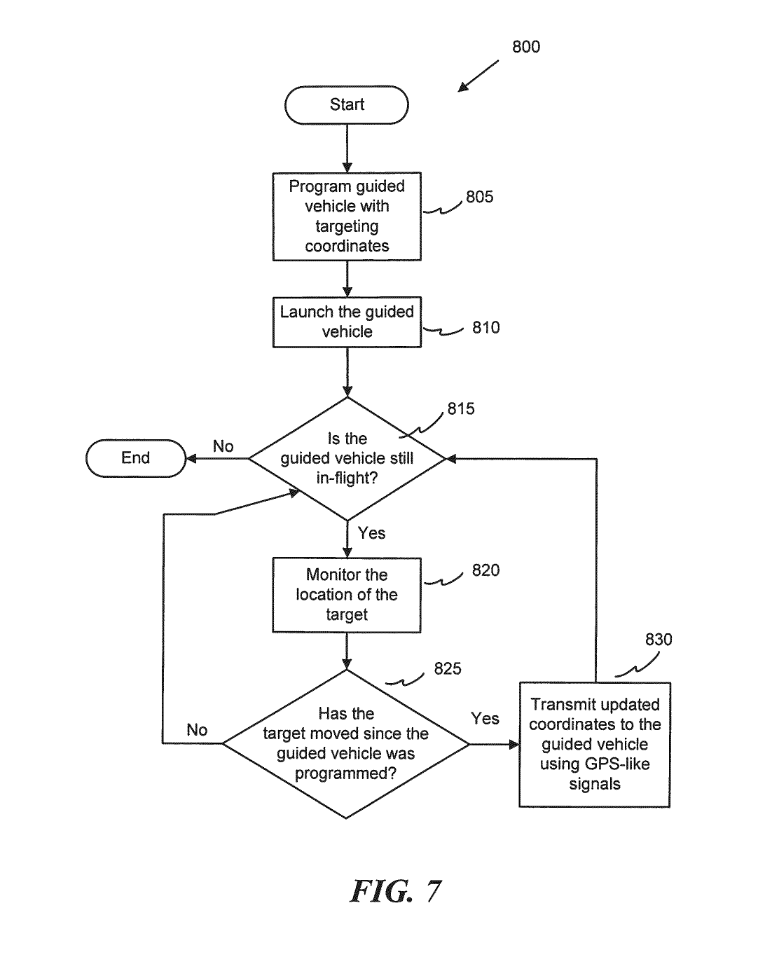

In operation, referring to FIG. 7, with further reference to FIG. 6, a process 800 for transmitting information to a guided vehicle, using the targeting system 700 includes the stages shown. The process 800, however, is exemplary only and not limiting. The process 800 can be altered, e.g., by having stages added, removed, or rearranged.

At stage 805 the guided vehicle is programmed with coordinates of a target. The coordinates can be, for example, information that represents the latitude and longitude of the target, although other location or guidance information can be used. At stage 810, the guided vehicle 710 is launched.

At stage 815, the command center 725 determines whether the guided vehicle 710 is still in flight. If the guided vehicle 710 is no longer in flight, the process 800 ends. If the guided vehicle 710 is still in flight, the process 800 continues.

At stage 820, the location of the target 730 is monitored by, for example, the command center 725 using radar. At stage 825, the command center 725 determines if the target has moved (or the destination has changed) from the targeting (or destination) coordinates programmed into the guided vehicle 710 in stage 805. If the targeting information does not require updating, the process 800 returns to stage 815. If the targeting information requires updating, at stage 830 the targeting system 700 transmits updated targeting (or destination) coordinates encoded in GPS-like signals to the guided vehicle 710 via the satellite 705 and/or the transmitter 715 using for example, the process 200 (of FIG. 4) and/or the process 300 (of FIG. 5). Alternatively, the targeting system 700 can transmit control information that changes the direction and/or speed of the guided vehicle 710 to control time of arrival and destination of the guided vehicle 710.

While communication with GPS enabled guided vehicles has been disclosed, other applications and types of communications are possible. For example, GPS-like signals can be used to transmit information to unmanned aerial vehicles, military aircraft, ground stations, individual troops, etc.

Other embodiments are within the scope of the invention. For example, due to the nature of software, functions described above can be implemented using software, hardware, firmware, hardwiring, or combinations of any of these. Features implementing functions can also be physically located at various positions, including being distributed such that portions of functions are implemented at different physical locations.

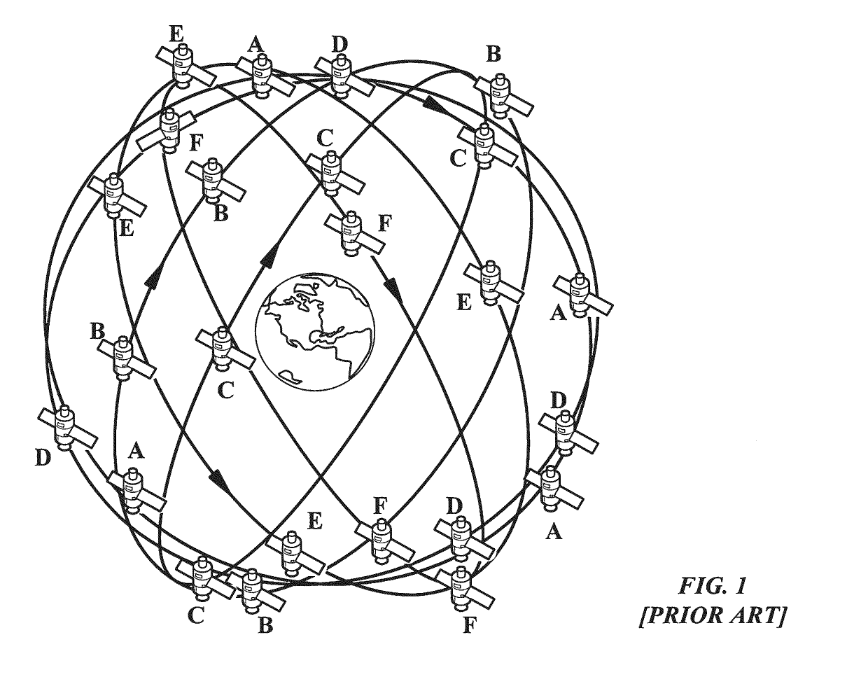

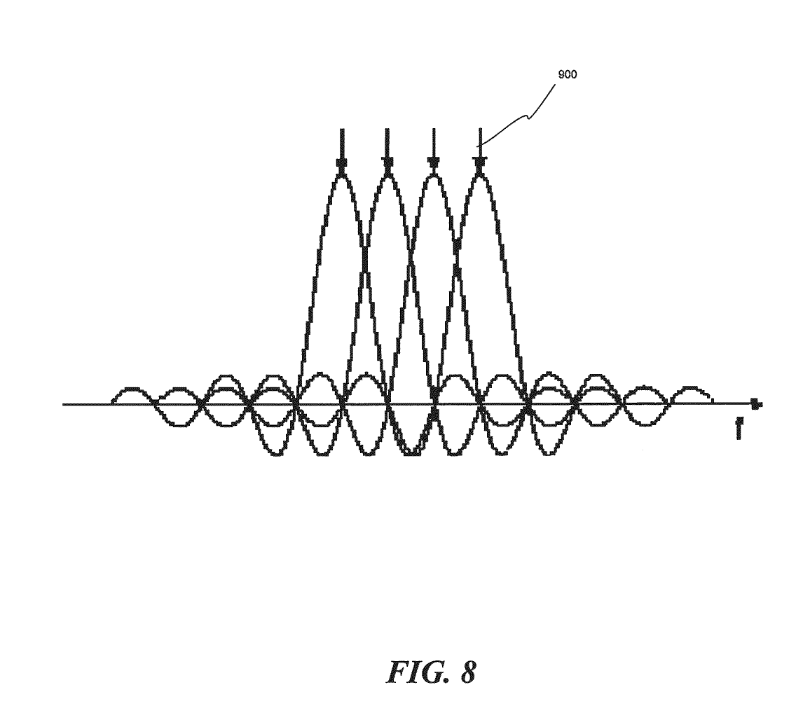

While FIG. 1 has been described in context of a single GPS receiver (i.e., the GPS receiver 105), other quantities are possible. The GPS satellites 20, 30, and 40 can be configured to transmit other information. The GPS receivers 105 can require upgrades/updates to use the method and systems described herein, such as software updates, firmware updates, hardware updates, etc. The PRN codes used to modulate the information can be totally orthogonal, or partially orthogonal. When two carrier frequencies are totally orthogonal to one another, the frequencies are chosen such that a receiver can reject an unwanted interfering signal, regardless of the intensity of the interfering signal. For example, when multiple modulation frequencies are used, each frequency overlaps with surrounding frequencies. When the signals are orthogonal, however, the points at which a desired frequency is measured, all other frequencies are zero (e.g., arrow 900 in FIG. 8). The LI band and/or the L5 band is preferably used for “life-critical” information (e.g., navigation information provided to a commercial airliner), although other frequency bands can be used. While some signals have been described as “GPS-like,” other formats are possible. For example, the navigation message format of a standard GPS signal can be replaced by another message format.

Further, while the description above refers to the invention, the description may include more than one invention.

What is claimed is:

1. A method comprising:
selecting a plurality of predefined pseudo-random noise (PRN) codes from a set of PRN codes used to transmit global positioning (GPS) signals;
receiving non-GPS information;
transmitting multiple information streams in a plurality of GPS compatible signals containing the non-GPS information according to the plurality of predefined PRN codes;
wherein the non-GPS information includes information adapted to be interpreted by an intended receiving device.

2. The method of claim 1 wherein transmitting multiple information streams comprises transmitting from a mobile platform.

3. The method of claim 1 wherein transmitting multiple information streams comprises transmitting the multiple information streams to an element in flight.

4. The method of claim 3 wherein the element in flight comprises a global positioning system aided munition.

5. The method of claim 1 wherein the non-GPS information comprises an image file.

6. The method of claim 1 wherein the non-GPS information comprises video data or files.

7. The method of claim 1 wherein the non-GPS information comprises software updates.

8. The method of claim 1 wherein the non-GPS information comprises encrypted data.

9. A method comprising:
selecting a plurality of predefined pseudo-random noise (PRN) codes from a set of PRN codes used to transmit global positioning (GPS) signals;
receiving non-GPS information;
transmitting a single information stream split into multiple streams in a plurality of GPS compatible signals containing the non-GPS information according to the plurality of predefined PRN codes;
wherein the non-GPS information includes information adapted to be interpreted by an intended receiving device.

10. A system comprising:
a PRN code selector adapted to select a plurality of pre-defined pseudo-random noise (PRN) codes from a set of PRN codes used to transmit global positioning system (GPS) signals; and
a GPS transmitter adapted to receive non-GPS information and produce a plurality of GPS compatible signals containing the non-GPS information according to the plurality of selected PRN codes; and
wherein the non-GPS information includes information adapted to be interpreted by an intended receiving device.

11. The system of claim 10 wherein the GPS transmitter adapted to receive the non-GPS information receives a single information stream and splits the single information stream into multiple streams for transmission according to the plurality of selected PRN codes.

12. The system of claim 10 wherein the GPS transmitter adapted to receive the non-GPS information receives a plurality of information streams and transmits corresponding ones of the plurality of information streams according to corresponding ones of the plurality of selected PRN codes.

13. The system of claim 10 wherein the GPS transmitter comprises a mobile platform.

14. The system of claim 10 wherein the GPS transmitter transmits to a flying intended receiving device.

15. The system of claim 14 wherein the GPS transmitter transmits to a global positioning system aided munition.

16. The system of claim 10 wherein the GPS transmitter transmits the GPS-compatible signal at a lower duty cycle than the corresponding GPS satellite associated with the selected PRN code.

17. The system of claim 16 wherein the duty cycle comprises a duty cycle that is 10-30% of the duty cycle of the corresponding GPS satellite associated with the selected PRN codes.

18. The system of claim 10 wherein the non-GPS information includes control information adapted to control operation of the intended receiving device.

19. The system of claim 18 wherein the control information is adapted to cause the intended receiving device to self-destruct.
